(19) United States
(12) Patent Application Publication
(10) Pub. No.: US 2016/0295874 A1
(43) Pub. Date: Oct. 13, 2016

(54) FROZEN MEAT PATTIES

(71) Applicant: YOOJI, Pessac (FR)

(72) Inventors: Remi Mathey, Agen (FR); Frederic Ventre, Sainte Eulalie (FR); Marc Vignolle, Les Ulis (FR)

(21) Appl. No.: 15/100,661

(22) PCT Filed: Dec. 8, 2014
(86) PCT No.: PCT/FR2014/053209

§ 371 Date: Jun. 1, 2016

(30) Foreign Application Priority Data
Dec. 6, 2013 (FR) 1302868

(51) Int. Cl. A23B 4/01; B65B 63/08; B65B 31/00; B65D 81/20; A23B 4/06; B65B 55/14

(52) U.S. Cl. CPC A23B 4/012; A23B 4/068; A23L 13/00; B65B 55/14; B65B 31/00; B65D 81/2007; B65B 63/08; A23V 2002/00

(57) ABSTRACT

A method for preparing meat-based foodstuffs, comprises the steps of: step 1: a first vacuum cooking heat treatment in a packaging in a moisture saturated atmosphere, is applied to foodstuffs having a meat content equal to or greater than 95%, and without the addition of salt; step 1.1: the foodstuffs having undergone the first vacuum cooking heat treatment are broken down to form elements smaller than two millimeters in the pasty state; step 2: the foodstuffs in the pasty state are repackaged in different receptacles of a container, individually packaged in a partial or total vacuum, in order to undergo a second pasteurization heat treatment in a moisture saturated atmosphere; step 3: the foodstuffs having undergone the second pasteurization heat treatment in individual portions, are rapidly cooled and frozen to −18° C. in the individual receptacles of the container.

### BACKGROUND

The field of the invention is the field of foodstuffs for babies (under the age of 36 months), elderly people and persons at risk: persons suffering from various pathologies causing difficulty with chewing or swallowing, or having undergone surgical procedures obliging them to favor a liquid or pasty food (e.g. gastrectomy, gastroplasty).

The objective of the invention is to provide a nutritionally balanced, simple, healthy food with a good taste for babies, elderly people and persons at risk.

The products currently available are usually:
so-called complete mixed meals mixing vegetables, starchy food and proteins
home mincing of pieces of meat, taken, for example from a steak, after cooking.

The existing industrial products (sterile canned food technology) are balanced but have a disappointing taste, and after opening the containers thereof (jar, plate, tray, packet, bowl . . . ), the contents must be eaten within a short time.

Home-made products taste good but they have various disadvantages:
the amount taken, which may be of the order of 10 g, is not very accurate;
the amount taken is small as compared to the total amount of foodstuff that had to be cooked, which results in leftovers and thus waste;
a risk exists for pieces of bones or fish bones being present in the quantity taken both before and after mincing.

### SUMMARY

The invention relates to a method for preparing meat-based foodstuffs.

According to the invention, the method comprises the following successive steps:
step 1: a first vacuum cooking heat treatment in a packaging in a moisture saturated atmosphere, is applied to foodstuffs having a meat content equal to or greater than 95%, and without the addition of salt,
step 1.1: the foodstuffs having undergone the first vacuum cooking heat treatment are broken down to form elements smaller than two millimeters in the pasty state
step 2: the foodstuffs in the pasty state are repackaged in different receptacles of a container, individually packaged in a partial or total vacuum, in order to undergo a second pasteurization heat treatment in a moisture saturated atmosphere,
step 3: the foodstuffs having undergone the second pasteurization heat treatment in individual portions, are rapidly cooled and frozen to −18° C. in the individual receptacles of the container.

According to another characteristic, the first vacuum cooking heat treatment of step 1 is performed in a cooking unit, at an ambient temperature of 60 to 95° C. for 30 to 60 minutes so as to reach an internal temperature of the foodstuffs of about 60 to 95° C.

According to yet another characteristic, the second pasteurization heat treatment of step 2 is performed in a cooking unit at an ambient temperature of 60 to 95° C. for about 15 to 30 minutes, so as to reach sufficient pasteurization to preserve the product.

The invention also relates to a packaging for meat-based foodstuffs, comprising a container provided with different receptacles each containing foodstuffs having a meat content equal to or greater than 95% and without the addition of salt, packaged individually, in a partial or total vacuum, cooked, pasteurized and frozen according to the above method. The foodstuffs according to the invention are thus meat-based, cooked, minced, packaged and frozen.

The foodstuffs according to the invention are minced very finely. Such fine mincing facilitates the eating thereof by babies or elderly people or persons at risk.

According to another characteristic of the invention, such cooked, minced, packaged and frozen meat-based foodstuffs are packaged in several portions with defined quantities. Taking a precise amount of food is thus easy.

The portions can be packaged in various forms:
Loose, individually wrapped or not in a container;
in a container such as a “tray”, which contains several individually wrapped portions, with the option of taking one or more portions, without opening the packaging of the other portions.

When the portion is individually packaged, the packaging can be provided in a total or partial vacuum.

According to another characteristic of the invention, the foodstuffs have a “cohesive-fragile” consistency. This consistency makes it possible to use the foodstuffs by giving them various sizes tailored to the consumer: pieces, small fragments or fine crumbs at the time of use thereof.

According to another characteristic of the invention, the proportion of meat in the finished product is equal to or greater than 95%.

The invention also relates to a method for preparing meat-based foodstuffs, which consists of two main steps:
step 1: the foodstuffs are cooked and broken down into pieces
step 2: the foodstuffs are re-agglomerated and pasteurized

During step 1, cooking and breaking down are successive operations.

During step 2, re-agglomeration and pasteurization can be simultaneously or successively performed.

If re-agglomeration and pasteurization are performed simultaneously, pasteurization may be carried out in a total or partial vacuum, in the final packaging.

### BRIEF DESCRIPTION OF THE DRAWINGS

FIG. 1 is a top view of a multi-serving packaging in a vacuum.

FIG. 2 shows a front view of the same packaging.

### DETAILED DESCRIPTION

Meat: beef, veal, pork, lamb, chicken, other poultry meat and fish meat . . .
“Cohesive-fragile” consistency: State of the product enabling the user to cut it into pieces, or reduce it to small fragments or fine crumbs as he/she chooses at the time of use.
Container of the “tray” type: Packaging grouping servings.
Babies: Infants and toddlers under 36 months of age.
Persons at risk: People suffering from various, not necessarily chronic, disorders or pathologies causing difficulty with chewing or swallowing, or having undergone surgical procedures obliging them to favor a liquid or pasty food (e.g. gastrectomy, gastroplasty).

The foodstuffs according to the invention are characterized in that they are very finely minced, which favors a better ingestion by babies, elderly people and persons at risk. The size of the elements that constitute such foodstuffs is less than two millimeters and preferably less than one millimeter.

Another characteristic of the invention: the foodstuffs have a “cohesive-fragile” consistency, making it possible to break them down easily and effortlessly into pieces from a few millimeters to a few tenths of millimeters in size using current eating utensils (fork, knife and back of the spoon). The foodstuffs can thus be easily adapted to the various consumers' chewing, swallowing and digestion abilities by the person who prepares the meals.

This “cohesive-fragile” consistency has similarities with the consistency of crackers, which can be easily broken down into pieces, small fragments or fine crumbs.

The foodstuffs preferably consist, for more than 95%, of meats, and without the addition of salt. This composition makes it possible to obtain homogeneous and interesting foodstuffs as regards nutrition and health. They can easily be reheated in a microwave oven, which makes their use very simple.

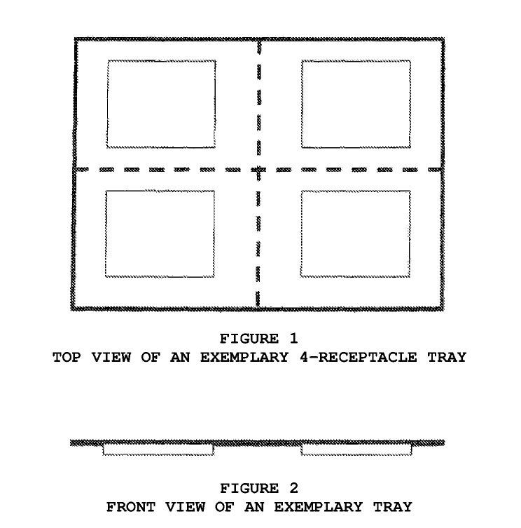

The foodstuffs are preferably packaged in a multi-receptacle container, each containing a portion. A container of this type, called a “tray” is shown in FIGS. 1 and 2. Each portion is placed in a vacuum and isolated from the other ones by the packaging materials being welded together. The assembly is subjected to pasteurization under a partial or total vacuum. Thus when used, each portion can be individualized, which makes it possible to adapt the amount to the consumer's age and appetite.

After reheating and breaking down, the foodstuffs can be conveniently mixed with vegetable purees and starchy food to have a complete meal.

Pasteurization in a partial or total vacuum provides the foodstuffs with the required food safety characteristics.

In an alternative embodiment, the foodstuffs can be packaged in a more basic packaging. The foodstuffs can, for example, be bare in the packaging.

The foodstuff manufacturing method takes place in two phases:
A first phase consists in cooking and breaking down meats. The two operations can be simultaneous or successive.
A second phase consists in re-agglomerating and pasteurizing the foodstuffs. These two operations can be simultaneous or successive.

This two-phase manufacturing helps giving the products the required health and use properties.

The frozen material (beef, veal, pork, chicken, turkey, duck and other poultry and fish) is then subjected to thawing followed by a first heat treatment in a vacuum in a packaging, in a moisture saturated atmosphere in a cooking unit, at an ambient temperature of 60 to 95° C. for 30 to 60 minutes so as to reach an internal temperature of about 60 to 95° C. If the material is fresh or not frozen, the thawing phase is not necessary.

After cooling, the material is reduced to a thin paste (e.g. by crushing or intensive cuttering).

This material in the pasty state is repackaged (for instance in 10 g patties) in plastic trays, in a partial or total vacuum and sealed so as to undergo a second heat treatment in a moisture saturated atmosphere in the cooking unit at an ambient temperature of 60 to 95° C. for 15 to 30 minutes, so as to reach a sufficient pasteurization to preserve the product. The tray may contain 4 10 g portions, for instance.

Alternative methods can be used:
For example, the first heat treatment in the packaging can be replaced by thawing and cooking in a churn in a partial vacuum or not.
For example, the first heat treatment in the packaging can be replaced by thawing and cooking more or less simultaneously with the cuttering in a heating cutter in a vacuum or not.

The foodstuff is then rapidly cooled and frozen down to −18° C. in the same tray.

The method according to the invention makes it possible to manufacture foodstuffs with a high or even a very high meat content (equal to or greater than 95% and thus more particularly with 100% meat) and without addition of salt, fat and/or any additional binding agent (i.e. those which are not naturally present in meat) like cream, brine or any other binding agent, and which however will come in a compact form when frozen, and will have, when thawed, a capacity to crumble into small fragments, several millimeters or even one millimeter in size.

The foodstuff packaged according to the invention thus has the advantage of not containing any binding agent nor any additional fat or external element which are not those naturally present in meats, while having high compactness and cohesion when frozen, and being packaged in a vacuum in individual portions after heat treatments in a vacuum having prevented any evaporation of the water from the base meat, having guaranteed the preservation of such meat from the exudate formed when cooking, and limited the formation of unwanted microbiological compounds and thus the rancidity of fat during the storage of the frozen foodstuff.

For this purpose, the method according to the invention mainly consists in:

1) applying to foodstuffs with a meat content equal to or greater than 95%, with such meat content thus being able to reach 100%, a first heat treatment aiming at cooking them in a packaging (like a plastic bag with a capacity of for example two or three liters) in a vacuum and in a moisture saturated atmosphere.

Cooking in a packaging, in a vacuum and in a moisture saturated atmosphere prevents the water contained in the foodstuffs from evaporating, avoids evaporation or prevents any other type of loss of the drip formed during cooking which remains in the packaging and is reabsorbed by the cooked foodstuffs.

This step is performed in a cooking unit, at an ambient temperature of 60 to 95° C. for 30 to 60 minutes so as to reach an internal temperature of the foodstuffs of about 60 to 95° C.

During a subsequent step 1.1, the foodstuffs that have undergone the first vacuum cooking heat treatment above were broken down using a chopper or a butcher's knife to form elements of less than two millimeters, making them easy to ingest by fragile people. The cooked and then minced foodstuffs are in the pasty state, but not gelled.

It is indeed important to mince meats once they are cooked, and not when they are raw to prevent the formation of a compact and non-friable gel (like sausages preparation material) which would not meet the purpose of the invention to provide a foodstuff that easily crumbles once thawed, into elements of a few millimeters, by simply applying pressure with the back of the fork for example).

2) During the next step, the cooked foodstuffs in the pasty, although friable state, free of any binding agent or fat other than those naturally present in meat, are repackaged in different receptacles of a container, individually wrapped, in a partial or total vacuum in a moist atmosphere. This step of pasteurization in a vacuum and in a moist atmosphere ensures both cohesion and compactness of the meat portion so constituted although every effort has been made to prevent the formation of a gel, improves the efficiency of the heat exchange for faster deep cooking, and limits the contact of meat with oxygen and thereby rancidity of the animal fats naturally present in meat during the frozen conservation thereof, and limits the development of unwanted microbial compounds, and this in the receptacles of the final packaging of the product, which are sealed prior to pasteurization to undergo a second heat treatment of pasteurization in a moisture saturated atmosphere.

Specifically, the second heat treatment of pasteurization of step 2 is performed in a cooking unit at an ambient temperature of 60 to 95° C. for 15 to 30 minutes, so as to reach a sufficient pasteurization for the product preservation).

3) Cooling is rapidly carried out in a deep-freezing cell for quickly lowering the temperature from 60 to 95° C. down to −18° C. of the foodstuffs cooked and pasteurized in their final packaging receptacles, in order to freeze them to −18C°.

The packaging of meat-based foodstuffs obtained using this method is in the form of a container provided with different receptacles, each containing foodstuffs having a meat content equal to or greater than 95% and without the addition of salt, cooked in a vacuum, pasteurized and frozen in a partial or total vacuum, with the receptacles being individually packaged and sealed. When the foodstuff meat content is between 95 and 100%, the complement to meat may consist for example of carbohydrates like flour (rice, corn, wheat, vegetables), especially originating from organic farming and without added fat.

These foodstuffs with a high meat content or even containing only meat, are free of any binding agent and additional fat other than those inherent to the meat or fish the foodstuffs are made of, exhibit despite this characteristic, a high cohesion when frozen and adequate friability when thawed and are presented in individual portions with a predetermined weight.

A user wishing to use one or more portions of this foodstuff for preparing a meal, can thaw the required portions, add the required fat (like olive oil) and separate this foodstuff by simply using a fork, into elements of a few millimeters in size.

Production of foodstuffs for babies, elderly people and persons at risk.

1-4. (canceled)

5. A method for preparing meat-based foodstuffs, comprising the steps of:
step 1: a first vacuum cooking heat treatment in a packaging in a moisture saturated atmosphere, is applied to foodstuffs having a meat content equal to or greater than 95%, and without the addition of salt;
step 1.1: the foodstuffs having undergone the first vacuum cooking heat treatment are broken down to form elements smaller than two millimeters in the pasty state;
step 2: the foodstuffs in the pasty state are repackaged in different receptacles of a container, individually packaged in a partial or total vacuum, in order to undergo a second pasteurization heat treatment in a moisture saturated atmosphere;
step 3: the foodstuffs having undergone the second pasteurization heat treatment in individual portions, are rapidly cooled and frozen to −18° C. in the individual receptacles of the container.

6. A method according to claim 1, wherein the first vacuum cooking heat treatment of step 1 is performed in a cooking unit, at an ambient temperature of 60 to 95° C. for 30 to 60 minutes so as to reach an internal temperature of the foodstuffs of about 60 to 95° C.

7. A method according to claim 1, wherein the second pasteurization heat treatment of step 2 is performed in a cooking unit at an ambient temperature of 60 to 95° C. for about 15 to 30 minutes, so as to reach a pasteurization sufficient to preserve the product.

8. A meat-based foodstuff packaging, comprising:
a container provided with different receptacles each containing foodstuffs having a meat content equal to or greater than 95% and without the addition of salt, packaged individually, in a partial or total vacuum, cooked, pasteurized and frozen according to the method according to claim 1.

1. A method for preparing meat-based foodstuffs, characterized in that it comprises the following successive steps:
step 1: a first vacuum cooking heat treatment in a packaging in a moisture saturated atmosphere, is applied to foodstuffs having a meat content equal to or greater than 95%, and without the addition of salt,
step 1.1: the foodstuffs having undergone the first vacuum cooking heat treatment are broken down to form elements smaller than two millimeters in the pasty state
step 2: the foodstuffs in the pasty state are repackaged in different receptacles of a container, individually packaged in a partial or total vacuum, in order to undergo a second pasteurization heat treatment in a moisture saturated atmosphere,
step 3: the foodstuffs having undergone the second pasteurization heat treatment in individual portions, are rapidly cooled and frozen to −18° C. in the individual receptacles of the container.

2. A method according to claim 1, characterized in that the first vacuum cooking heat treatment of step 1 is performed in a cooking unit, at an ambient temperature of 60 to 95° C. for 30 to 60 minutes so as to reach an internal temperature of the foodstuffs of about 60 to 95° C.

3. A method according to claim 1, characterized in that the second pasteurization heat treatment of step 2 is performed in a cooking unit at an ambient temperature of 60 to 95° C. for about 15 to 30 minutes, so as to reach a pasteurization sufficient to preserve the product.

4. A meat-based foodstuff packaging, characterized in that it comprises a container provided with different receptacles each containing foodstuffs having a meat content equal to or greater than 95% and without the addition of salt, packaged individually, in a partial or total vacuum, cooked, pasteurized and frozen according to the method according to one of claims 1 to 3.
